(19) United States
(12) Patent Application Publication
(10) Pub. No.: US 2007/0112977 A1
(43) Pub. Date: May 17, 2007

(54) ONLINE RINGTONE CREATION UTILITY AND SERVICE

(76) Inventors: Daniel J. Hornal, W.Lynwood, WA (US); Adam D. Eivy, Shoreline, WA (US)

Correspondence Address: WHITAKER LAW GROUP, Suite 304, 755 Winslow Way East, Bainbridge Island, WA, 98110, US

(21) Appl. No.: 11/558,828

(22) Filed: Nov. 10, 2006

Related U.S. Application Data
(60) Provisional application No. 60/735,722, filed on Nov. 10, 2005.

(51) Int. Cl. G06F 15/16

(52) U.S. Cl. 709/246

(57) ABSTRACT

The invention allows a user to connect to a remote location, such as a website, upload a sound file from their computer to the website, edit the sound file to the user's taste, and download the new sound file onto their mobile device. The user would typically use this music file as a ringtone. Alternatively, the user could connect to the remote location, identify a pre-loaded sound file at the remote location, edit the sound file to the user's taste, and download the new sound file onto their mobile device. In another alternative, the user could identify the new sound file as a ringback tone, perhaps resident at a service provider location.

### CROSS REFERENCE TO RELATED APPLICATIONS

This application claims priority to co-pending U.S. Provisional Patent Application No. 60/735,722 filed on Nov. 10, 2005 and entitled ONLINE RINGTONE CREATION UTILITY AND SERVICE.

### BACKGROUND OF THE INVENTION

Today, users often have mobile devices with the ability to announce an incoming call with a special ringtone. Often, mobile devices are sold with an initial set of ringtones that can be selected. In addition, many mobile devices allow the user to add new ringtones. However, users who wanted to add ringtones to their mobile devices, such as cellular phones, had two choices: either pay an organization for a pre-made ringtone, or go through a complicated process for creating a special ringtone that involves downloading specialized software.

Pre-made ringtones have two disadvantages: first, they tend to be expensive. Second, they may not be the part of the song that the user wants to listen to. In addition, if a user desires to create a special audio file with his or her own music, most users have no idea how to actually convert that audio file to a ringtone and get that ringtone installed on their mobile device.

An adequate solution to these problems has eluded those skilled in the art, until now.

### SUMMARY OF THE INVENTION

This invention allows a user to connect to a remote location, such as a website, upload a sound file from their computer to the website, edit the sound file to the user's taste, and download the new sound file onto their mobile device. The user would typically use this music file as a ringtone. Alternatively, the user could connect to the remote location, identify a pre-loaded sound file at the remote location, edit the sound file to the user's taste, and download the new sound file onto their mobile device. In another alternative, the user could identify the new sound file as a ringback tone, perhaps resident at a service provider location.

This invention overcomes the problems in the existing technology. For instance, users may not need to pay a licensing fee to the rights-owner of the music as they already have purchased a copy, so ringtones created through this method can be cheaper. The user can customize the sound file to their desire, so the ringtone will always be the part of the song that they want to hear. Additionally, this network-based process provides an alternative to downloading specialized software. The network-based process can be simpler, more robust and powerful, and compatible across more devices than downloaded software. It's also possible to use the Internet or other computer networks to achieve integration with other services, such as a cell phone company's data network.

### BRIEF DESCRIPTION OF THE DRAWINGS

FIG. 1 is a functional block diagram generally illustrating a system for creating personalized ringtones for mobile devices.

FIG. 2 is a functional block diagram generally illustrating components of the ringtone creator introduced in conjunction with FIG. 1.

FIGS. 3-9 are illustrative screen representations of one embodiment of the present invention as used to create a personalized ringtone.

### DESCRIPTION OF EMBODIMENTS OF THE INVENTION

What follows is a detailed discussion of embodiments of the invention. Generally stated, these embodiments are directed at a system that allows a user to provide audio content, such as a digital audio file, to an online ringtone creation service. The user can use the ringtone creation service to clip a portion of the audio content for use in conjunction with the user's mobile device. To simplify this discussion, the term “ringtone” means any audible resource used in conjunction with a mobile device to announce a call either to the called party (“ringtone”) or to the calling party (“ringback tone”). Accordingly, when used throughout this document, the term “ringtone” includes both conventional ringtones and ringback tones.

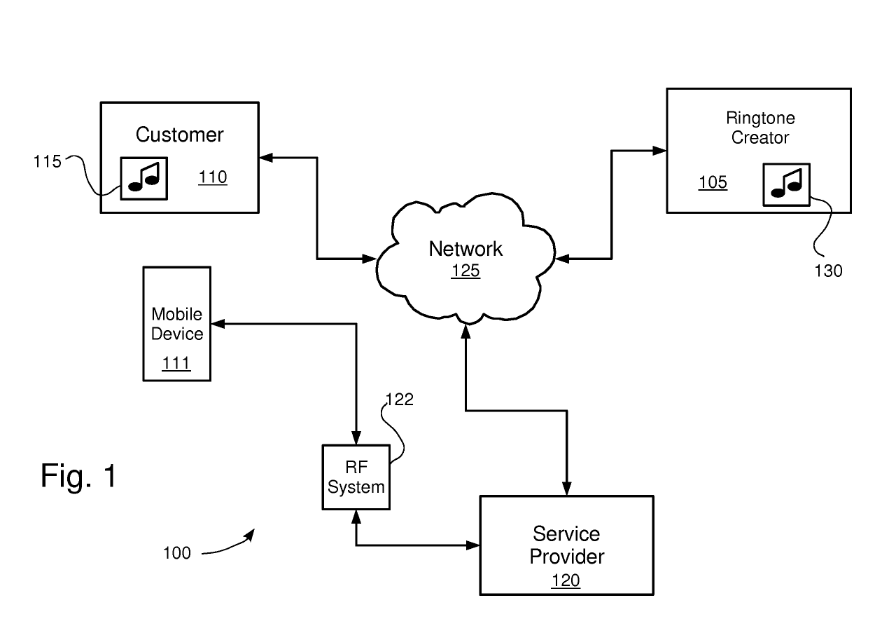

FIG. 1 is a functional block diagram generally illustrating components of a system 100 to enable a customer 110 to create personalized ringtones using an online service. The system 100 includes an online ringtone creator 105, and may additionally include a service provider 120.

The customer 110 is a computing system coupled to a network 125. The computing system could be any conventional or special purpose computing device with volatile and non-volatile memory and processing power. The customer 110 may also include at least one digital audio file 115, and browsing software for accessing resources over the network 125. The network 125 may be any interconnection of distributed computing functionality, such as a local area network, wide area network, the Internet, or the like.

The service provider 120 provides wireless communications services to users of mobile devices. The service provider typically includes or is coupled to a Radio Frequency (RF) system 122 for wireless communications with mobile devices, such as the user's mobile device 111. The RF system 122 typically enables mobile devices to couple to the Public Switched Telephone Network (PSTN) to make a receive telephone calls. The RF system 122 may additionally enable mobile devices to couple to other computing systems over the network 125 through the service provider 120.

The service provider 120 may offer its users a “ringback tone” service, which functions to play an audio file (a ringtone) of the user's choosing to a calling party that calls the user's mobile device. In conventional terminology, the “ringtone” is an audio file that is used to announce an incoming call on a mobile device to the called party, and the “ringback tone” is an audio file that is played back to the calling party attempting to initiate a call to the mobile device. The ringback tone replaces the ordinary monotone feedback that a calling party would otherwise hear when placing a call. According to this conventional terminology, the ringtone is stored on the mobile device while the ringback tone is stored at the service provider 120. However, since there may be no meaningful difference between the actual audio files used, the term “ringtone” will be used throughout this document to encompass both ringtones and ringback tones.

The mobile device 111 is used, typically, for mobile communications. Many examples of mobile devices exist and include cellular phones, portable phones, pocket PCs, smartphones, and the like. The mobile device 111 includes the ability to audibly announce an incoming call or communication using a locally-stored digital audio file (the ringtone). Typically, the user of the mobile device can choose a particular ringtone to use to announce incoming calls, sometimes even on a per-caller basis. Conventional mobile devices come pre-loaded with a selection of ringtones. In addition, most modern mobile devices include the ability to add new ringtones.

Ringtones are added to the mobile device 111 in one or more of several ways. For example, if the mobile device 111 is WAP enabled, the mobile device 111 can be coupled to a data source over the network 125, via the service provider 120, and download an audio file using the WAP protocol. Alternatively, if the mobile device 111 is data-ready such that it includes mobile browsing software and a data connection, it can couple directly to a data source over a data session established by the service provider 120 and download an audio data file. In still another alternative, if the mobile device 111 is e-mail capable, an audio data file could be e-mailed directly to the mobile device 111.

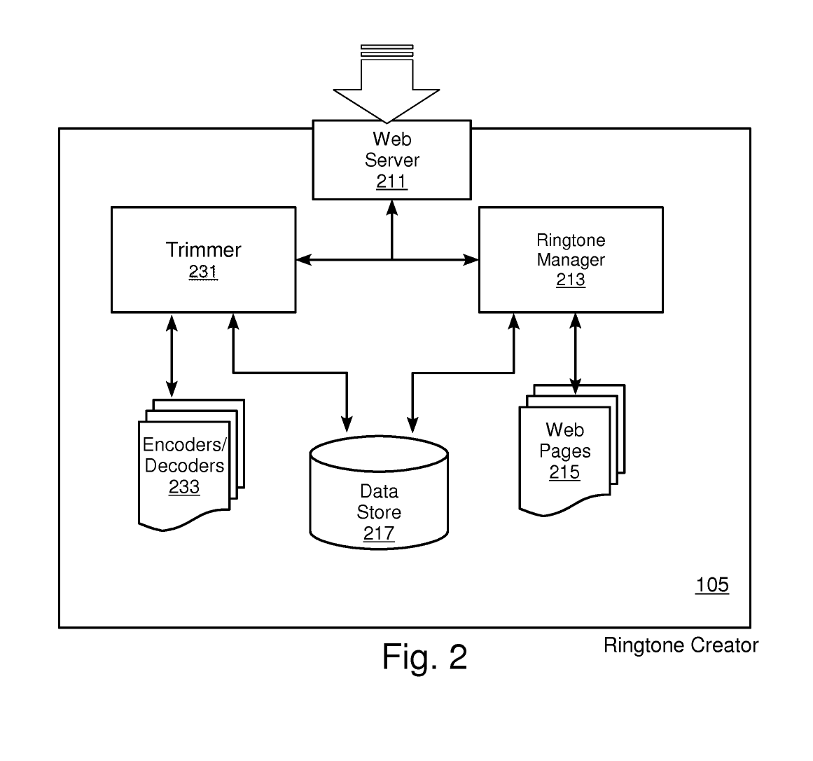

A ringtone creator 105 is a computing system coupled to the network 125 that provides ringtone creation services to other computing systems. The ringtone creator 105 of one particular embodiment is described in greater detail below in conjunction with FIG. 2. Generally stated, the ringtone creator 105 is configured to allow a user (e.g., customer 110) to edit or clip an audio file of the user's choosing for conversion to a new ringtone. The ringtone creator 105 is further configured to make the new ringtone available for use in conjunction with the user's mobile device 111. The new ringtone could be used on the mobile device 111 in the conventional manner, or it could be transmitted to the service provider 120 for use as a ringback tone.

In general operation, the customer 110 connects to the ringtone creator 105 over the network 125. The customer 110 either uploads the audio data file 115 to the ringtone creator 105, or selects from one or more audio data files already resident at the ringtone creator 105. The customer 110 interacts with the ringtone creator 105 to create a ringtone 130 by editing or clipping a portion of the uploaded or selected audio file. The ringtone creator 105 then makes the ringtone 130 available for use with the mobile device 111.

In one implementation, the ringtone creator 105 provides the customer 110 with a link (e.g., a hyperlink) to the ringtone 130 so that the user can navigate browsing software on the mobile device 111 to the ringtone 130 via the service provider 120 and the RF system 122. Alternatively, the ringtone creator 105 could electronically transmit the ringtone 130 to the mobile device 111, such as using e-mail, SMS messaging, MMS messaging, or the like.

FIG. 2 is a functional block diagram generally illustrating components of the ringtone creator 105 introduced above in conjunction with FIG. 1. The components illustrated in FIG. 2 are functional in nature and may be implemented in software, firmware, hardware, or any combination of these. In addition, the functionality described may be implemented in fewer or more actual components than those illustrated in FIG. 2. The components illustrated in FIG. 2 are for discussion purposes only.

The ringtone creator 105 is a computing system connected to a network. The ringtone creator 105 includes a web server 211, a ringtone manager 213, and a trimmer 231. The ringtone creator 105 may also include many other components not shown.

The web server 211 couples the ringtone creator 105 to other computing systems over a network, such as the Internet, using an inter-computing protocol, such as HyperText Transfer Protocol (HTTP), Wireless Application Protocol (WAP), or the like. The web server 211 serves up locally stored markup language pages, such as HyperText Markup Language (HTML) pages, WML (Wireless Markup language) pages, extensible Markup Language (XML) pages, and the like. The web server 211 may also support executing scripts or other simple programmatic functionality (e.g., Javascript, Java applets, Active X controls, and the like).

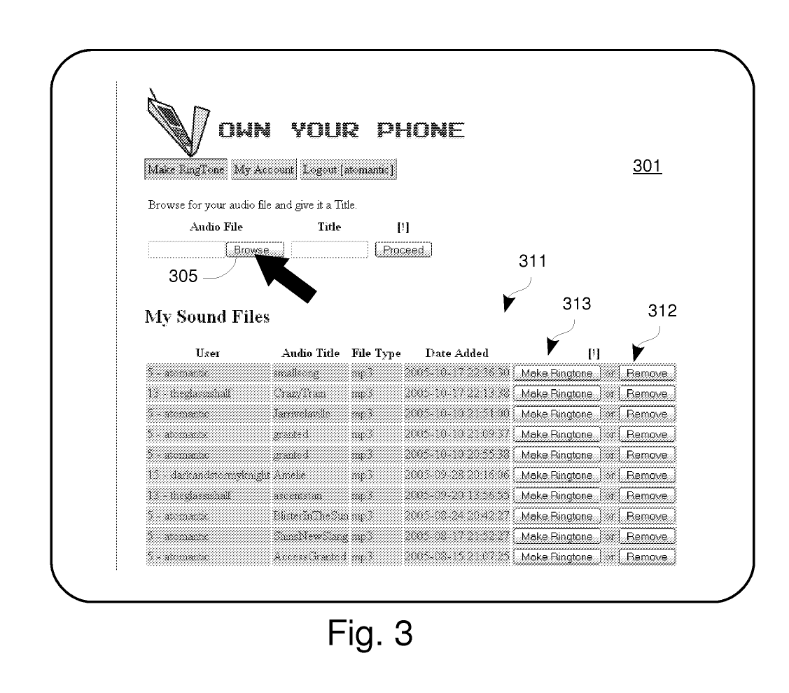

Locally stored web pages 215 represent particular markup language pages served by the web server 211. The web pages 215 include pages and/or online access functionality that enables a remote user (e.g., customer 110 or mobile device 111 of FIG. 1) to interact with the various functional components of the ringtone creator 105. Examples of several web pages 215 that may be served by the web server 211 to achieve these various operations and advantages are illustrated in FIGS. 3-9 and described below.

A data store 217 is included for storing data on the ringtone creator 105. Examples of the types of data that may be stored in the data store 217 include digital audio files, customer account information, and the like.

The ringtone manager 213 is a component configured to host interactions between a customer interacting with the ringtone creator 105 and each of the several other functional components. For example, the ringtone manager 213 may interact with the web server 211 and the web pages 215 to authenticate and authorize customers to login, to manage and update a customer's account information, to launch and terminate other functional components as needed, to marshal data between and among the several components, and other functions as needed. Additionally, the ringtone manager 213 may be configured to administer the transfer of new digital audio files into the ringtone creator 105, and the delivery of new ringtones to a customer after creation.

The trimmer 231 is a component configured to allow editing, trimming, clipping, or otherwise modifying a digital audio file (generally referred to as “trimming”) to extract a selected portion of the entire audio content for use as a ringtone. For example, if a user owns a digital version of a song or other audio recording, and the user has a favorite part, the trimmer 231 allows the user to clip only that favorite portion for use as a ringtone. The trimmer 231 employs various encoders and decoders 233 in support of trimming a digital audio file.

While illustrated as a functional component on the same computing system as the ringtone manager 213, the trimmer 231 could alternatively be implemented on a separate computing system that is accessible by the ringtone creator 105. In fact, collocating each of the functional components shown in FIG. 2 is for simplicity of discussion only. Any one or more components could be implemented on separate computing systems, distributed over two or more computing systems, or combined in any other workable manner.

It has been described here that a user uploads his own digital audio file to the ringtone creator 105. Alternatively, the ringtone creator 105 could provide digital audio files which are licensed by the maintainer of the ringtone creator 105. For instance, a library of digital audio files that represent several songs in one or more genres of music could be kept locally at the ringtone creator 105. Perhaps the maintainer of the ringtone creator 105 has negotiated a licensing arrangement whereby any of the maintainer's customers could purchase a small portion of a song for use as a ringtone at a lower licensing rate than purchasing the entire digital audio file. In this way, a user that visits the ringtone creator 105 could be presented with a pre-populated library of songs to choose from.

### Illustrative Screen Displays of One Embodiment

What follows here is a series of illustrative screen displays that illustrate how a user might interact with an online service that implements one embodiment of the present invention. Generally stated, a user that desires to create a personalized ringtone visits the online service, such as using a conventional general purpose computer connected to the Internet. The online service could be implemented using the components described above in conjunction with the systems illustrated in FIGS. 1 and 2.

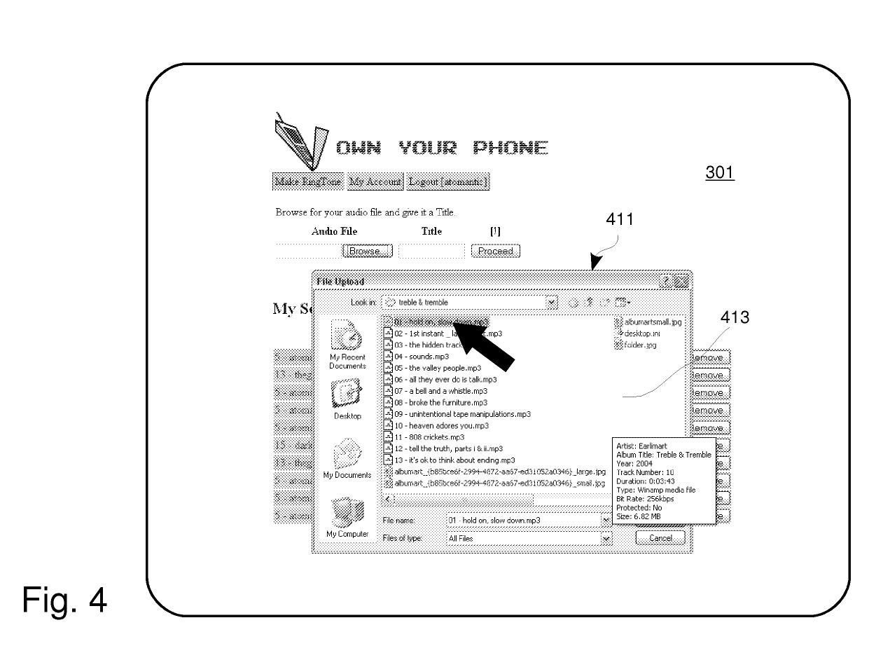

Beginning with FIG. 3, the user visits an online location or web site hosted by the online service. The user's session may begin, after logging in, by being presented with an account page 301 that allows the user to upload an audio file from the user's computer to the online service by clicking a “Browse” button 305. Alternatively, the user could select an audio file from the user's library 311. The library 311 could be audio files that the user has previously uploaded, or perhaps audio files provided by the online service. If the user selects the browse button 305, screen display changes to the illustration in FIG. 4.

As shown in FIG. 4, a file selection dialog 411 is presented to the user. The file selection dialog 411 includes a listing 413 of files that are local to the user's computer system. The file selection dialog 411 allows the user to navigate the local file system to select one or more of the user's audio files to upload. The file selection dialog 411 closes once the user has selected the audio files to upload, returning the user to the account page 301.

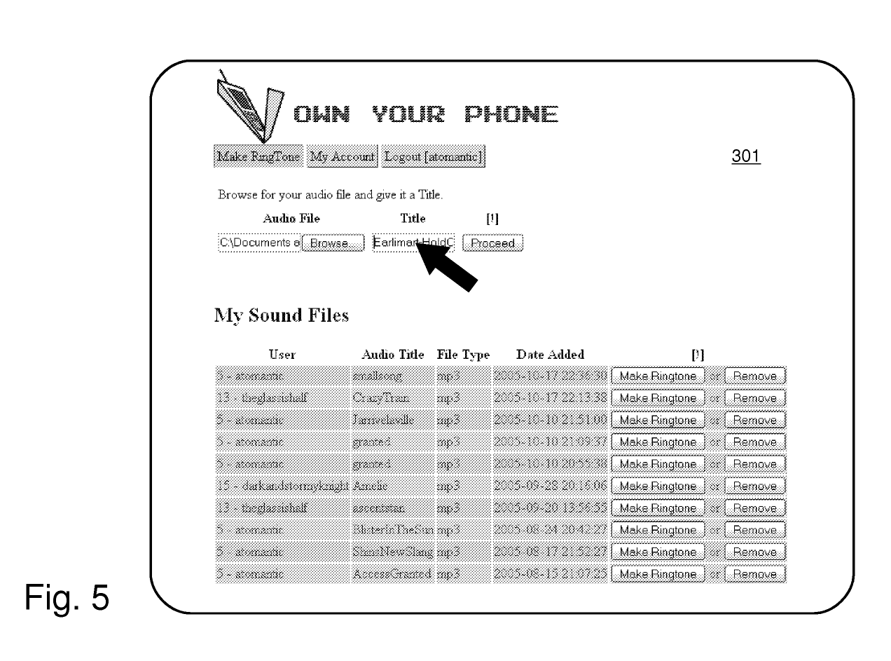

Turning to FIG. 5, the user may be provided an opportunity to give the selected audio file a title. The “title” can be any appropriate alphanumeric identifier of the user's choosing, such as the song's name, a catchy phrase, artist's name, or any other identifier. The title, if provided, can be used to name a ringtone created from the audio file. This feature allows the user to personalize his ringtones and distinguish them from other ringtones that may be installed on a mobile device. This naming portion of the process could also be done automatically, such as by performing an automated guess for a title based on the name of the audio file or from properties stored within or in conjunction with the audio file.

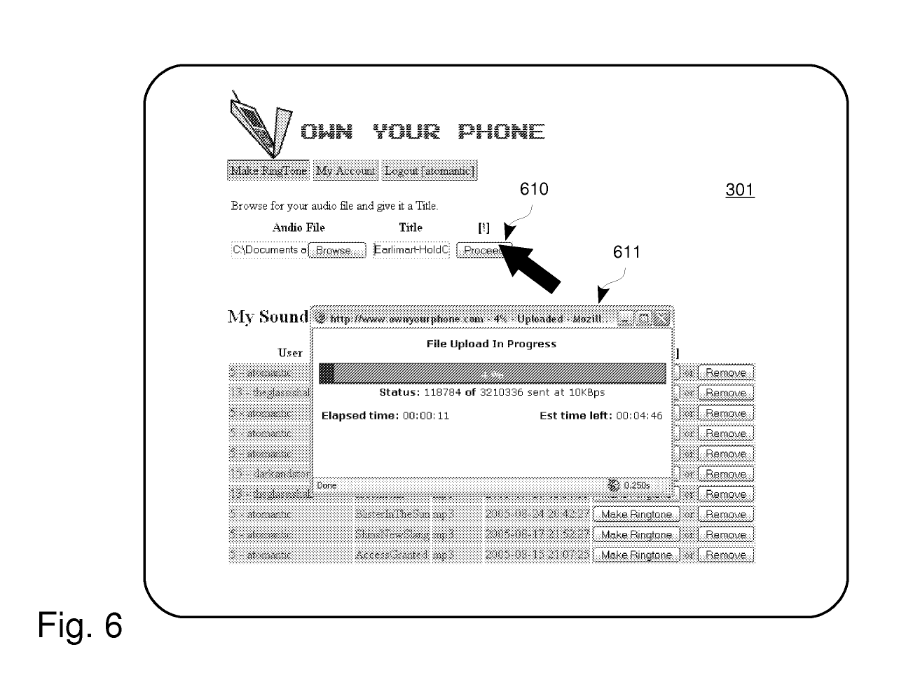

As shown in FIG. 6, after clicking a “proceed” button 610, the user's computing system initiates the upload of the selected audio file to the online service. The user may be presented with an upload dialog 611 so the user can monitor the progress of the upload.

Returning to FIG. 3, once the file upload is complete, the newly uploaded file appears in the user's library 311. To remove one or more of the files in the library 311, the user can click a “remove” button 312. To make a ringtone, the user selects a desired audio file and clicks a “make ringtone” button 313. Clicking the “make ringtone” button 313 initiates a ringtone creation utility, such as the trimmer 231 (FIG. 2).

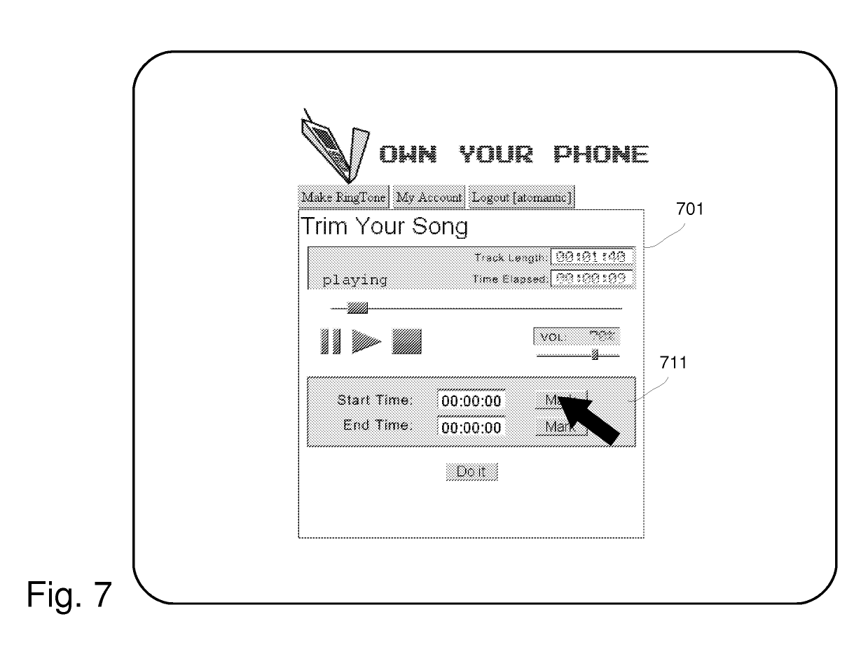

Turning now to FIG. 7, the online ringtone creation utility (e.g., trimmer 701 ) presents the user with a dialog that allows the user to review the selected audio file. The trimmer 701 enables the user to play the audio file from any part of the file. The trimmer 701 includes selection buttons 711 that allow the user to mark in and mark out a portion of the audio file to use as a ringtone. For example, the user may only want to use the refrain of the song as a ringtone, or perhaps he or she has a favorite passage. If the audio file is a personal recording made by the user, perhaps there is a portion that is of particular significance to the user. The trimmer 701 allows the user to pick precisely the right portion of the audio file to convert to a ringtone. The trimmer 701 can also have other functions, such as enabling a fade-in or fade-out of the ringtone, or perhaps blending portions of two or more ringtones.

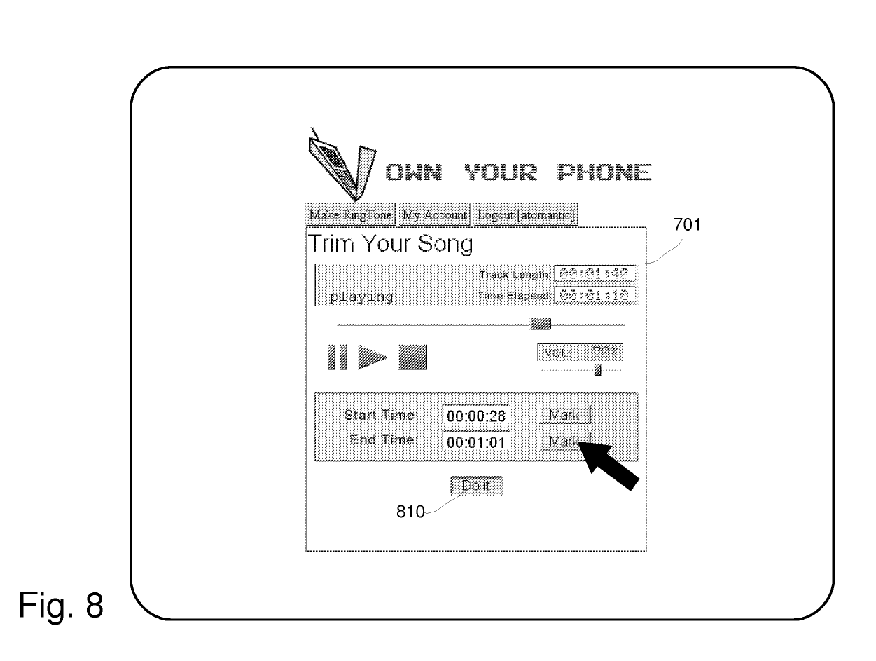

Turning to FIG. 8, the user marks both a start time and an end time that delineates the particular portion of the audio file to use. IF the user does not supply a start time, the ringtone will begin from the beginning of the audio file. If the user does not supply an end time, the ringtone will end at the end of the audio file. Upon completion, the user clicks a “do it” button 810, which causes the trimmer 701 to create the ringtone. Creating the ringtone may include decoding and re-encoding the selected portion of the audio file, and to save the ringtone in a format that is compatible with the user's mobile device.

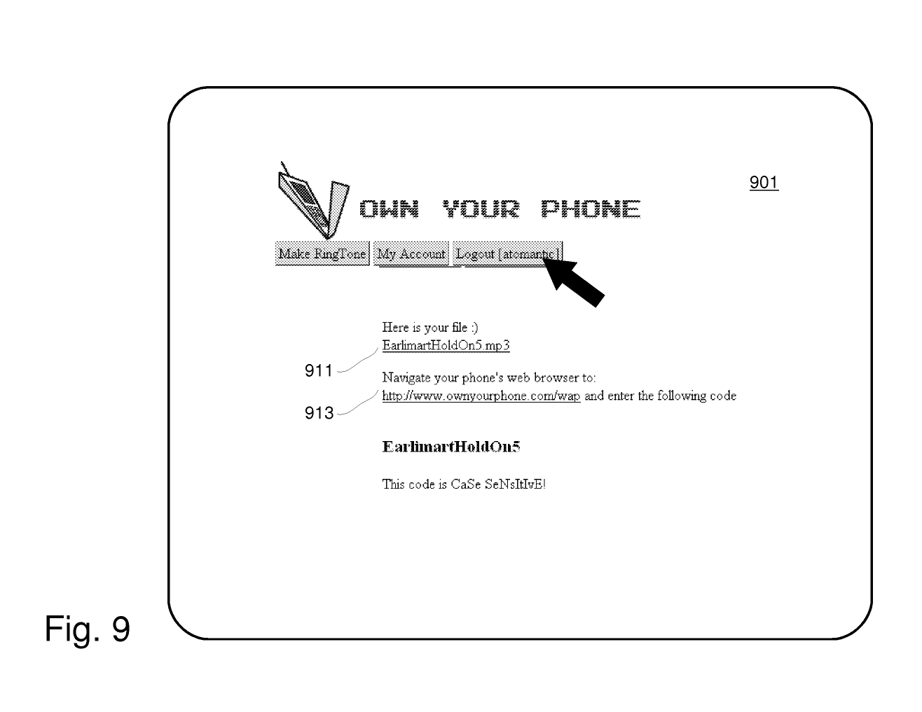

Turning to FIG. 9, when the ringtone has been created, the user is presented with a finish page 901 with information to facilitate making the ringtone available for use with the user's mobile device. For example, a hyperlink 911 may provide direct access to download the ringtone to the user's computer for later transfer to the mobile device. Alternatively, or in addition, the finish page 901 may include a URL 913 that can be accessed from a WAP enabled mobile device to download the ringtone directly. In this implementation, the user uses a phone web browser (e.g., a WAP browser) to navigate to a special page and enter a unique code. In other implementations, the user could have a text message, such as a Short Message Service (SMS) message, sent to the mobile device with information on how to proceed with the download.

In yet another implementation, the finish page 901 may provide the user with an option (not shown) to have the ringtone transmitted to a service provider for use as a ringback tone.

Although the processes envisioned by the invention may have been illustrated and described sequentially in the embodiments set forth in this document, in other embodiments, the operations described may be performed in different orders, multiple times, and/or in parallel. Further, in some embodiments, one or more operations described may be separated into different steps, combined, or even omitted in certain cases.

Reference may have been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

What is claimed is:

1. A computer-implemented method for creating a ringtone, comprising:
initiating an online session with a ringtone creation service over a network;
uploading a selected audio file to the ringtone creation service;
trimming a selected portion from the selected audio file into a ringtone file; and
activating a link associated with the ringtone file to cause the ringtone file to be associated with a mobile device.

2. The computer-implemented method recited in claim 1, further comprising uploading a new audio file to a library of audio files stored at the ringtone creation service.

3. The computer-implemented method recited in claim 2, wherein the library of audio files comprises a selection of commercial music files.

4. The computer-implemented method recited in claim 2, wherein the library of audio files comprises a selection of music files uploaded by a customer.

5. The computer-implemented method recited in claim 1, wherein activating the link comprises:
navigating a mobile device to the link;
downloading the ringtone file to the mobile device using a Wireless Application Protocol (WAP) instruction; and
installing the ringtone file in the mobile device for use in announcing incoming communication on the mobile device.

6. The computer-implemented method recited in claim 1, wherein activating the link causes the ringtone file to be electronically transmitted to the mobile device.

7. The computer-implemented method recited in claim 6, wherein the electronic transmission comprises at least one of an e-mail message, an SMS message, and/or an MMS message.

8. A computer-implemented method for creating a ringtone, comprising:
initiating an online session with a remote computing system over a network;
receiving an audio file from the remote computing system;
presenting a trimmer utility to the remote computing system, the trimmer utility enabling a portion of the audio file to be captured as a new ringtone file, the portion being selectable by the remote computing system;
storing the new ringtone file in a library associated with the remote computing system;
presenting to the remote computing system information to enable a mobile device to retrieve the new ringtone file; and
transmitting the new ringtone file to the mobile device upon request by the mobile device.

9. The computer-implemented method recited in claim 8, further comprising transmitting the new ringtone file to a service provider associated with the mobile device for use as a ringback tone.

10. A computer-readable medium encoded with computer-executable components, comprising:
a ringtone manager configured to interact with a remote computing system to facilitate receiving audio files from the remote computing system over a network;
a data store on which resides at least one audio file received from the remote computing system; and
a trimmer configured to capture a selected portion of the audio file and to store the portion as a ringtone file,
wherein the ringtone manager is further configured to make the ringtone file available using a Wireless Application Protocol (WAP) to a mobile device, the ringtone file being encoded in a format compatible with the mobile device.

11. The computer-readable medium recited in claim 10, wherein the trimmer executes on a same computing system as the ringtone manager.

12. The computer-readable medium recited in claim 10, wherein the trimmer executes on a different computing system as the ringtone manager.

13. The computer-readable medium recited in claim 10, wherein the ringtone manager is further configured to interact with the remote computing system using web pages.

14. The computer-readable medium recited in claim 10, wherein the ringtone file comprises a ringback tone file.
